(19) United States
(12) Patent Application Publication
(10) Pub. No.: US 2023/0276022 A1
(43) Pub. Date: Aug. 31, 2023

(54) USER TERMINAL, VIDEO CALL DEVICE, VIDEO CALL SYSTEM, AND CONTROL METHOD FOR SAME

(71) Applicant: Kyung Cheol KIM, Cheongju-si (KR)

(72) Inventor: Kyung Cheol KIM, Cheongju-si (KR)

(21) Appl. No.: 17/784,010

(22) PCT Filed: Dec. 7, 2020
(86) PCT No.: PCT/KR2020/017727

§ 371 Date: May 1, 2023

(30) Foreign Application Priority Data
Dec. 9, 2019 (KR) 10-2019-0162502

(51) Int. Cl. H04N 5/278; H04N 7/15; G10L 15/00; G10L 15/18; G10L 15/26

(52) U.S. Cl. CPC H04N 5/278; H04N 7/15; G10L 15/005; G10L 15/18; G10L 15/26

(57) ABSTRACT

Disclosed are a user terminal, a video call translation device, a video call translation system comprising same, and a control method for same. The video call translation device according to one aspect may comprise: a communications unit which supports a video call service between a plurality of user terminals via a communication network; an extraction unit which generates an image file and an audio file by using a video call-associated video file collected from each of the plurality of user terminals, and extracts original language information from at least one of the image file and the audio file; a translation unit which generates translation information from the original language information; and a control unit which controls transmission of an interpreted/translated video in which at least one of the extracted original language information and the translation information is mapped to the video call-associated video file.

### TECHNICAL FIELD

The present invention relates to a user terminal, a video call device, a video call system, and a control method for the same, which provide a real-time original text/translation service while doing a multi-party video call, as well as a one-to-one video call.

### BACKGROUND ART

With the advancement in IT technology, video calls are frequently made between users, and in particular, people of various countries around the world use video call services for the purpose of sharing contents, hobbies, and the like, as well as business purposes.

However, it is practically difficult to make a video call with an interpreter in every video call from the aspect of cost and time, and researches on a method of providing real-time original text/translation services for video calls are under progress.

### DISCLOSURE OF INVENTION

### Technical Problem

An object of the present invention is to support various functions that can further facilitate exchange and understanding of opinions by providing an original text/translation service in real-time between callers using various languages, further facilitate exchange and understanding of opinions among the hearing impaired, as well as the visually impaired, by providing an original text/translation service through at least one among a voice and text, and further facilitate communications, such as an electronic blackboard function, a text transmission function, a speaking right setting function, and the like.

### Technical Solution

To accomplish the above object, according to one aspect of the present invention, there is provided a video call device comprising: a communications unit for supporting a video call service between a plurality of user terminals through a communication network; an extraction unit for generating an image file and an audio file using a video call-related video file collected from each of the plurality of user terminals, and extracting original language information from at least one among the image file and the audio file; a translation unit for generating translation information from the original language information; and a control unit for controlling transmission of an interpreted/translated video, in which at least one among the extracted original language information and the translation information is mapped to the video call-related video file.

In addition, the original language information may include at least one among voice original language information and text original language information, and the translation information may include at least one among voice translation information and text translation information.

In addition, the extraction unit may extract voice original language information for each caller by applying a frequency band analysis process to the audio file, and generate text original language information by applying a voice recognition process to the extracted voice original language information.

In addition, the extraction unit may detect a sign language pattern by applying an image processing process to the image file, and generate text original language information based on the detected sign language pattern.

According to another aspect of the present invention, there is provided a user terminal comprising: a terminal communication unit for supporting a video call service through a communication network; and a terminal control unit for controlling to display, on a display, a user interface configured to provide an interpreted/translated video, in which at least one among original language information and translation information is mapped to a video call-related video file, and provide an icon for receiving at least one or more video call-related setting commands and at least one or more translation-related setting commands.

In addition, the at least one or more video call-related setting commands may include at least one among a speaking right setting command capable of setting a right to speak of a video caller, a command for setting the number of video callers, a blackboard activation command, and a text transmission command.

In addition, the terminal control unit may control to display, on the display, a user interface configured to be able to change a method of providing the interpreted/translated video according to whether or not the speaking right setting command is input, or to provide a pop-up message including information on a caller having a right to speak.

In addition, the terminal control unit may control to display a user interface configured to provide a virtual keyboard in a preset region on the display when the text transmission command is received.

According to another aspect of the present invention, there is provided a control method of a video call device, the method comprising the steps of: receiving a video call-related video file from a plurality of user terminals through a communication network; extracting original language information for each caller using at least one among an image file and an audio file generated from the video call-related video file; generating translation information of the original language information translated according to a language of a selected country; and controlling to transmit an interpreted/translated video, in which at least one among the original language information and the translation information is mapped to the video call-related video file.

In addition, the extracting step may include the steps of: extracting voice original language information for each caller by applying a frequency band analysis process to the audio file; and generating text original language information by applying a voice recognition process to the extracted voice original language information.

### Advantageous Effects

A user terminal, a video call device, a video call system including the same, and a control method for the same according to an embodiment further facilitate exchange and understanding of opinions by providing an original text/translation service in real-time between callers using various languages.

A user terminal, a video call device, a video call system including the same, and a control method for the same according to another embodiment further facilitate exchange and understanding of opinions among the hearing impaired, as well as the visually impaired, by providing an original text/translation service through at least one among a voice and text.

A user terminal, a video call device, a video call system including the same, and a control method for the same according to another embodiment support various functions that can further facilitate communications, such as an electronic blackboard function, a text transmission function, a speaking right setting function, and the like, so that a further efficient video call may be progressed.

### BRIEF DESCRIPTION OF THE DRAWINGS

FIG. 1 is a view for explaining various types of user terminals according to an embodiment.

FIG. 2 is a block diagram schematically showing the configuration of a video call system according to an embodiment.

FIG. 3 is a view schematically showing a user interface screen displayed on a display during a video call between two callers according to an embodiment.

FIG. 4 is a view schematically showing a user interface screen displayed on a display during a video call among five callers according to an embodiment.

FIG. 5 is a view schematically showing a user interface screen displayed on a display when any one of five callers has a right to speak according to an embodiment.

FIG. 6 is a view showing a user interface screen configured to receive various setting commands according to an embodiment.

FIG. 7 is a flowchart schematically showing the operation flow of a video call device according to an embodiment.

### BEST MODE FOR CARRYING OUT THE INVENTION

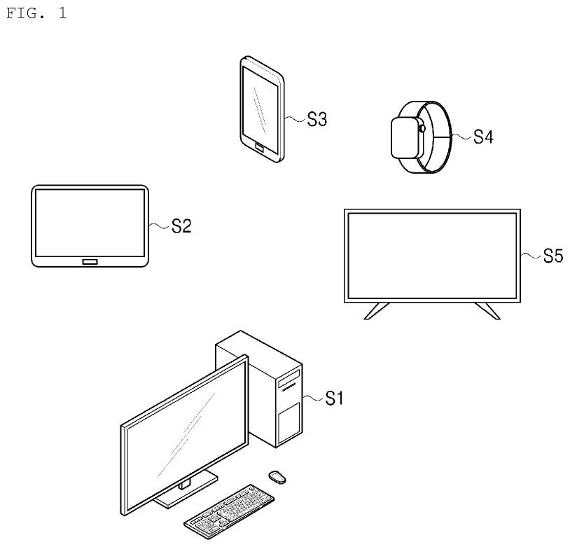

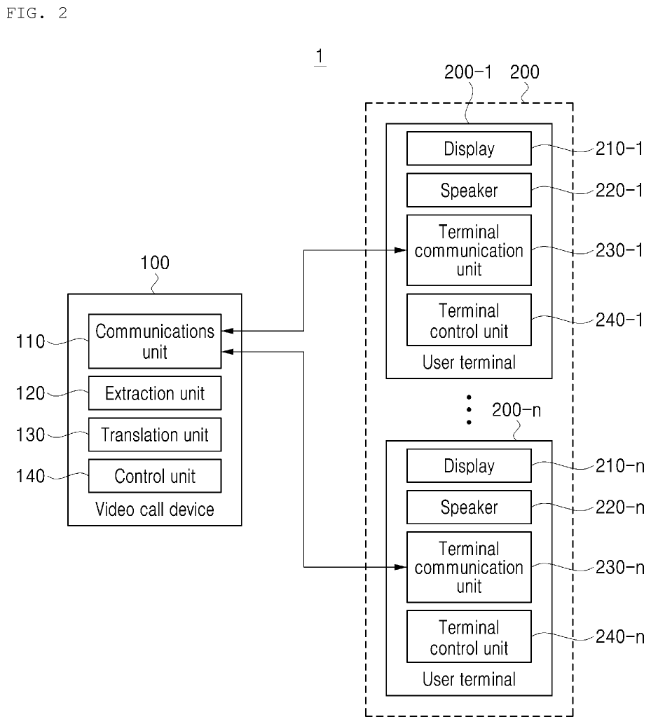

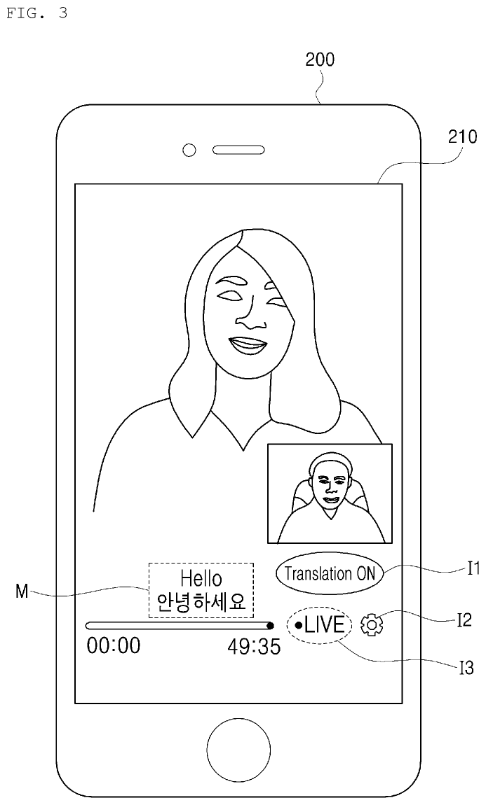

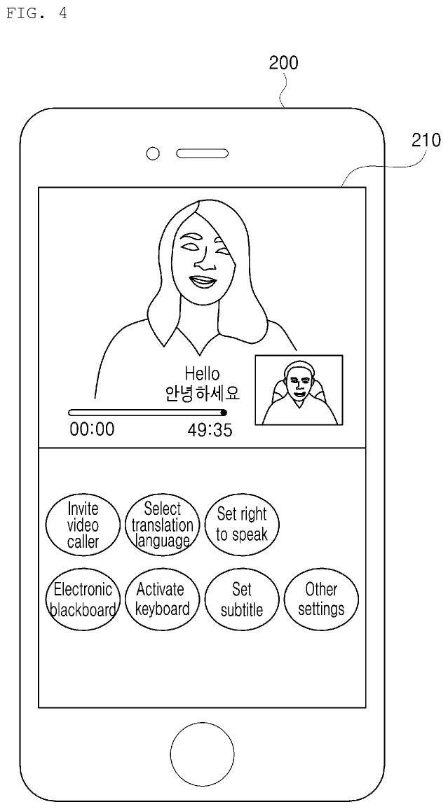

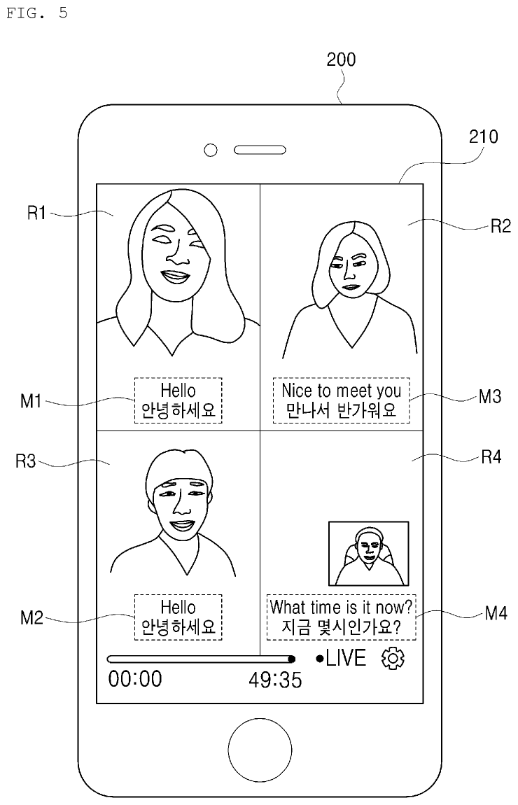

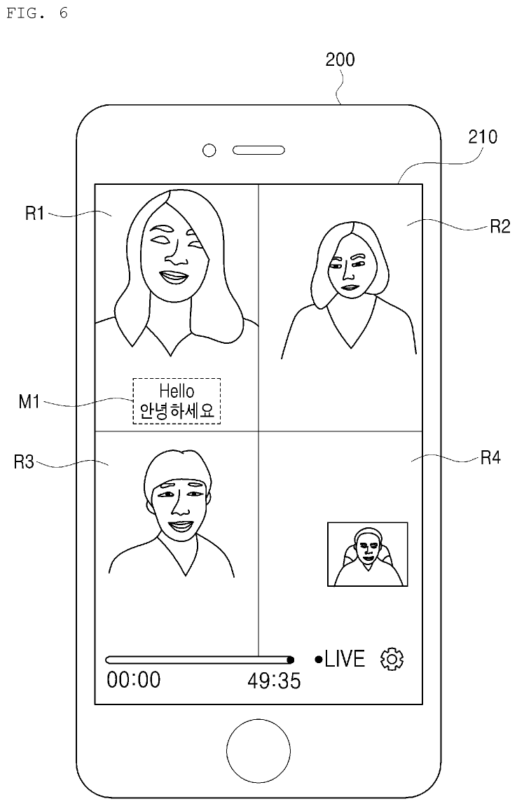

FIG. 1 is a view for explaining various types of user terminals according to an embodiment, and FIG. 2 is a block diagram schematically showing the configuration of a video call system according to an embodiment. In addition, FIG. 3 is a view schematically showing a user interface screen displayed on a display during a video call between two callers according to an embodiment, and FIG. 4 is a view schematically showing a user interface screen displayed on a display during a video call among five callers according to an embodiment. In addition, FIG. 5 is a view schematically showing a user interface screen displayed on a display when any one of five callers has a right to speak according to an embodiment, and FIG. 6 is a view showing a user interface screen configured to receive various setting commands according to an embodiment. Hereinafter, they will be described together to prevent duplication of description.

The user terminal described below includes all devices that support user's video call services as a display and a speaker, as well as a processor capable of performing various arithmetic operations, are embedded therein. For example, the user terminal includes a desktop PC S1, a tablet PC S2, and the like shown in FIG. 1. In addition, the user terminal includes a TV S5 (including a smart TV, an IPTV, and the like) shown in FIG. 1, as well as a portable mobile terminal such as a smart phone S3 and a wearable terminal S4 such as a watch or glasses that can be attached to the user's body as shown in FIG. 1, and there is no limitation.

Although a user terminal of a smart phone type among the various types of user terminals described above will be described hereinafter as an example for convenience of explanation, it is not limited thereto. In addition, in the following descriptions, a person who uses a video call service using a user terminal will be interchangeably referred to as a user or a caller for convenience of explanation.

Meanwhile, the video call device described below includes all devices embedded with a communication module capable of transmitting and receiving various types of data through a communication network, and a processor capable of performing various arithmetic operations. For example, the video call device includes smart TVs, IPTVs, and the like, as well as the laptop PCs, desktop PCs, tablet PCs, smart phones, PDAs, and wearable terminals described above. In addition, the video call device may include a server or the like embedded with a communication module and a processor, and there is no limitation.

Referring to FIG. 2, a video call system 1 includes user terminals 200 (200-1, . . . , 200-n, n≥1) and a video call device 100 that supports video calls between the user terminals 200 and provides an original text/translation service for the video calls.

Referring to FIG. 2, the video call device 100 may include a communications unit 110 for supporting a video call service between the user terminals 200 through a communication network; an extraction unit 120 for generating an image file and an audio file using a video call-related video file received through the communications unit 110, and extracting original language information based on the generated files; a translation unit 130 for generating translation information by translating the original language information; and a control unit 140 for providing translation information by controlling the overall operation of the components in the video call device 100.

Here, the communication unit 110, the extraction unit 120, the translation unit 130, and the control unit 140 may be implemented separately, or at least one among them may be implemented to be integrated in a system-on-chip (SOC). However, since there may be one or more system-on-chips in the video call device 100, it is not limited to integration in one system-on-chip, and there is no limitation in the implementation method. Hereinafter, the components of the video call device 100 will be described in detail.

The communication unit 110 may exchange various types of data with external devices through a wireless communication network or a wired communication network. Here, the wireless communication network means a communication network capable of wirelessly transmitting and receiving signals including data.

For example, the communication unit 110 may transmit and receive wireless signals between devices through a base station in a 3-Generation (3G), 4-Generation (4G), or 5-Generation (5G) communication method, and in addition, it may exchange wireless signals including data with terminals within a predetermined distance through a communication method, such as wireless LAN, Wi-Fi, Bluetooth, Zigbee, Wi-Fi Direct (WFD), Ultra-wideband (UWB), Infrared Data Association (IrDA), Bluetooth Low Energy (BLE), Near Field Communication (NFC), or the like.

In addition, the wired communication network means a communication network capable of transmitting and receiving signals including data by wire. For example, the wired communication network includes Peripheral Component Interconnect (PCI), PCI-express, Universal Serial Bus (USB), and the like, but it is not limited thereto. The communication network described below includes both a wireless communication network and a wired communication network.

The communication unit 110 may receive a video call-related video file from a user terminal 200 on a video call through a video call service. The video call-related video file is a data received from the user terminal 200 during a video call, and may include image information providing visual information and voice information providing auditory information.

In supporting a video call by controlling the communication unit 110 in response to a request from the user terminal 200, the control unit 140 may transmit various files or the like needed for communications between callers, such as only a video call-related video file, an interpreted/translated video file, in which at least one among original language information and translation information is mapped to the video call-related video file, an image file generated through an electronic blackboard function or a text file generated through a text function, and the like. A detailed description of the control unit 140 will be described below.

Referring to FIG. 2, the video call device 100 may be provided with an extraction unit 120. The extraction unit 120 may generate an image file and an audio file using the video call-related video file received through the communication unit 110.

Language information is included in the image file and the audio file, and the extraction unit 120 according to an embodiment may extract original language information from the image file and the audio file. The original language information described below is information extracted from a communication means such as a voice, a sign language, or the like included in the video, and the original language information may be extracted as a voice or text.

Hereinafter, for convenience of explanation, original language information configured of a voice will be referred to as voice original language information, and original language information configured of text will be referred to as text original language information. For example, when a character (caller) in a video call-related video speaks ‘Hello’ in English, the voice original language information is the voice ‘Hello’ spoken by the caller, and the text original language information means text ‘Hello’ itself. Hereinafter, a method of extracting the voice original language information from the audio file will be described.

Voices of various callers may be mixed in the image file, and when these various voices are provided at the same time, users may be confused, and it is difficult to translate. Accordingly, the extraction unit 120 may extract voice original language information for each of the callers from the audio file through a frequency band analysis process.

The voice of each individual may be different according to gender, age group, pronunciation tone, pronunciation strength, or the like, and therefore, a person making a voice may be distinguished by analyzing the frequency band. Accordingly, the extraction unit 120 may extract voice original language information by analyzing the frequency band of the audio file and separating the voice of each character appearing in the video based on the analysis result.

The extraction unit 120 may generate text original language information by converting the voice original language information into text, and separately store the voice original language information and the text original language information for each caller.

The method of analyzing the frequency band of the audio file and the method of converting voice original language information into text original language information may be implemented as a data in the form of an algorithm or a program and previously stored in the video call device 100, and the extraction unit 120 may separately generate original language information using the previously stored data.

Meanwhile, a specific caller may use a sign language during a video call. In this case, unlike the method of extracting voice original language information from the audio file and then generating text original language information from the voice original language information, the extraction unit 120 may extract the text original language information directly from an image file. Hereinafter, a method of extracting text original language information from an image file will be described.

The extraction unit 120 may detect a sign language pattern by applying an image processing process to an image file, and generate text original language information based on the detected sign language pattern.

Whether or not to apply an image processing process may be set automatically or manually. For example, when a sign language translation request command is received from the user terminal 200 through the communication unit 110, the extraction unit 120 may detect a sign language pattern through the image processing process. As another example, the extraction unit 120 may determine whether a sign language pattern exists in the image file by automatically applying an image processing process to the image file, and there is no limitation.

The method of detecting a sign language pattern through an image processing process may be implemented as a data in the form of an algorithm or a program and previously stored in the video call device 100, and the extraction unit 120 may detect a sign language pattern included in the image file using the previously stored data, and generate text original language information from the detected sign language pattern.

The extraction unit 120 may store the original language information by mapping it with specific character information.

For example, as the extraction unit 120 identifies a user terminal 200 that has transmitted a specific voice, and then maps an ID preset to a corresponding user terminal 200, a nickname preset by the user (caller), or the like to the original language information, a viewer may accurately grasp which caller makes which speech although a plurality of users simultaneously makes a voice.

As another example, when a plurality of callers is included in one video call-related video file, the extraction unit 120 may adaptively set character information according to a preset method or according to the characteristics of a caller detected from the video call-related video file. As an embodiment, the extraction unit 120 may identify the gender, age group, and the like of a character who makes a voice through a frequency band analysis process, and arbitrarily set and map a character's name determined to be the most suitable based on the result of the identification.

The control unit 140 may control the communication unit 110 to transmit original language information and translation information mapped with character information to the user terminal 200, so that users may identify who the speaker is more easily. A detailed description of the control unit 140 will be described below.

Referring to FIG. 2, the video call device 100 may be provided with a translation unit 130. The translation unit 130 may generate translation information by translating the original language information in a language desired by the caller. In generating the translation information in a language input by the caller, the translation unit 130 may generate a translation result as text or a voice. As the video call system 1 according to an embodiment provides each of the original language information and the translation information as a voice or text, there is an advantage in that the hearing impaired and the visually impaired may also use the video call service.

Hereinafter, translation of the original language information in a language requested by a user is referred to as translation information for convenience of explanation, and the translation information may also be configured in the form of a voice or text, like the original language information. At this point, translation information configured of text will be referred to as text translation information, and translation information configured of a voice will be referred to as voice translation information.

The voice translation information is voice information dubbed with a specific voice, and the translation unit 130 may generate voice translation information dubbed in a preset voice or a tone set by a user. The tone that each user desires to hear may be different. For example, a specific user may desire voice translation information of a male tone, and another user may desire voice translation information of a female tone. Accordingly, the translation unit 130 may generate the voice translation information in various tones so that users may watch more comfortably. Alternatively, the translation unit 130 may generate voice translation information in a voice tone similar to the speaker's voice based on a result of analyzing the speaker's voice, and there is no limitation. As the video call device 100 according to an embodiment provides voice translation information, even the visually impaired may receive a video call service more easily.

As a translation method and a voice tone setting method used for translation, data in the form of an algorithm or a program may be previously stored in the video call device 100, and the translation unit 130 may perform translation using the previously stored data.

Referring to FIG. 2, the video call device 100 may be provided with a control unit 140 for controlling the overall operation of the components in the video call device 100.

The control unit 140 may be implemented as a processor, such as a micro control unit (MCU) capable of processing various arithmetic operations, and a memory for storing control programs or control data for controlling the operation of the video call device 100 or temporarily storing control command data or image data output by the processor.

At this point, the processor and the memory may be integrated in a system-on-chip (SOC) embedded in the video call device 100. However, since there may be one or more system-on-chips embedded in the video call device 100, it is not limited to integration in one system-on-chip.

The memory may include volatile memory (also referred to as temporary storage memory) such as SRAM and DRAM, and non-volatile memory such as flash memory, Read Only Memory (ROM), Erasable Programmable Read Only Memory (EPROM), Electrically Erasable Programmable Memory (EEPROM), and the like. However, it is not limited thereto, and may be implemented in any other forms known in the art.

In an embodiment, control programs and control data for controlling the operation of the video call device 100 may be stored in the non-volatile memory, and the control programs and control data may be retrieved from the non-volatile memory and temporarily stored in the volatile memory, or control command data or the like output by the processor may be temporarily stored in the volatile memory, and there is no limitation.

The control unit 140 may generate a control signal based on the data stored in the memory, and may control the overall operation of the components in the video call device 100 through the generated control signal.

For example, the control unit 140 may support a video call by controlling the communication unit 110 through a control signal. In addition, through the control signal, the control unit 140 may control the extraction unit 120 to generate an image file and an audio file from a video call-related file, for example, a video call-related video file, and extract original language information from at least one among the image file and the audio file.

The control unit 140 may facilitate communications between users of various countries by generating and transmitting an interpreted/translated video, which is generated by mapping at least one among original language information and translation information to a video call-related video file received from a plurality of user terminals, to each user terminal.

At this point, only the original language information or the translation information may be mapped in the interpreted/translated video, or the original language information and the translation information may be mapped together.

For example, when only text original language information and text translation information are mapped in the interpreted/translated video, the text original language information and the text translation information related to a corresponding speech may be included in the interpreted/translated video as a subtitle whenever a caller makes a speech. As another example, when only voice translation information and text translation information are mapped in the interpreted/translated video, voice translation information dubbed in a language of a specific country may be included in the interpreted/translated video whenever a caller makes a speech, and the text translation information may be included a subtitle.

Meanwhile, the control unit 140 may change the method of providing a video call service and an original text/translation service based on a setting command received from the user terminal 200 through the communication unit 110 or based on a previously set method.

For example, when a command for setting the number of video callers is received from the user terminal 200 through the communication unit 110, the control unit 140 may restrict access of the user terminal 200 according to a corresponding command.

As another example, when a separate text data or image data is received from the user terminal 200 through the communication unit 110, the control unit 140 may transmit the received text data or image data together with an interpreted/translated video file so that opinions may be exchanged between the callers more reliably.

As another example, when a speaking right setting command, e.g., a command for limiting speech or a command for setting a speech order, is received from the user terminal 200 through the communication unit 110, the control unit 140 may transmit only an interpreted/translated video of a user terminal having a right to speak among a plurality of user terminals 200 in accordance with a corresponding command. Alternatively, the control unit 140 may transmit a pop-up message including information on a right to speak in accordance with a corresponding command, together with the interpreted/translated video, and there is no limitation in the implementation method.

In supporting a video call service and a translation service as described below and supporting the service as described above, applications that can be set in various ways may be stored in advance in the user terminal 200 in accordance with preferences of individual users, and the users may perform various settings using a corresponding application. Hereinafter, the user terminal 200 will be described.

Referring to FIG. 2, the user terminal 200 may include a display 210 (210-1, . . . , 210-n) for visually providing various types of information to a user, a speaker 220 (220-1, . . . , 220-n) for aurally providing various types of information to a user, a terminal communication unit 230 (230-1, . . . , 230-n) for exchanging various types of data with external devices through a communication network, and a terminal control unit 240 (240-1, . . . , 240-n) for supporting a video call service by controlling the overall operation of the components in the user terminal 200 (n≥1).

Here, the terminal communication unit 230 and the terminal control unit 240 may be implemented separately or implemented to be integrated in a system-on-chip (SOC), and there is no limitation in the implementation method. Hereinafter, each component of the user terminal 200 will be described.

The user terminal 200 may be provided with a display 210 that visually provides various types of information to the user. According to an embodiment, the display 210 may be implemented as a liquid crystal display (LCD), a light emitting diode (LED), a plasma display panel (PDP), an organic light emitting diode (OLED), a cathode ray tube (CRT), and the like, but it is not limited thereto, and there is no limitation. Meanwhile, when the display 210 is implemented as a touch screen panel (TSP) type, a user may input various explanation commands by touching a specific region on the display 210.

The display 210 may display a video call-related video, and may receive various control commands through a user interface displayed on the display 210.

The user interface described below may be a graphical user interface, which graphically implements a screen displayed on the display 210, so that the operation of exchanging various types of information and commands between the user and the user terminal 200 may be performed more conveniently.

For example, the graphical user interface may be implemented to display icons, buttons and the like for easily receiving various control commands from the user in some regions of the screen displayed through the display 210, and display various types of information through at least one widget in some other regions, and there is no limitation.

For example, as shown in FIG. 3, a video of a caller and a counterpart caller on a video call may be displayed on the display 210, and a graphical user interface configured to provide an icon I1 for inputting a translation command, an icon I2 for inputting various setting commands, an emoticon I3 for providing information on the state of a video call service, and original language/translation information M may also be displayed on the display 210.

The terminal control unit 240 may control to display the graphical user interface as shown in FIG. 3 on the display 210 through a control signal. The display method, arrangement method and the like of widgets, icons, emoticons, and the like configuring the user interface may be implemented as a data in the form of an algorithm or a program and previously stored in the memory of the user terminal 200 or in the memory of the video call device 100. Accordingly, the terminal control unit 240 may control to generate a control signal using the previously stored data and display the graphical user interface through the generated control signal. A detailed description of the terminal control unit 240 will be described below.

Meanwhile, referring to FIG. 2, the user terminal 200 may be provided with a speaker 220 capable of outputting various sounds. The speaker 220 is provided on one side of the user terminal 200 to output various sounds included in the video call-related video file, and there is no limitation in the types of sounds that can be output. The speaker 220 may be implemented through various types of known sound output devices, and there is no limitation.

The user terminal 200 may be provided with a terminal communication unit 230 for exchanging various types of data with external devices through a communication network.

The communication unit 230 may exchange various types of data with external devices through a wireless communication network or a wired communication network. Here, since the detailed description of the wireless communication network and the wired communication network are described above, they will be omitted.

The terminal communication unit 230 may provide a video call service by exchanging a video call-related video file, an interpreted/translated video file, and the like in real-time with other user terminals through the video call device 100.

Referring to FIG. 2, the user terminal 200 may be provided with a terminal control unit 240 for controlling the overall operation of the user terminal 200.

The terminal control unit 240 may be implemented as a processor, such as an MCU capable of processing various arithmetic operations, and a memory for storing control programs or control data for controlling the operation of the user terminal 200 or temporarily storing control command data or image data output by the processor.

At this point, the processor and the memory may be integrated in a system-on-chip embedded in the user terminal 200. However, since there may be one or more system-on-chips embedded in the user terminal 200, it is not limited to integration in one system-on-chip.

The memory may include volatile memory (also referred to as temporary storage memory) such as SRAM and DRAM, and non-volatile memory such as flash memory, Read Only Memory (ROM), Erasable Programmable Read Only Memory (EPROM), Electrically Erasable Programmable Memory (EEPROM), and the like. However, it is not limited thereto, and may be implemented in any other forms known in the art.

In an embodiment, control programs and control data for controlling the operation of the user terminal 200 may be stored in the non-volatile memory, and the control programs and control data may be retrieved from the non-volatile memory and temporarily stored in the volatile memory, or control command data or the like output by the processor may be temporarily stored in the volatile memory, and there is no limitation.

The terminal control unit 240 may generate a control signal based on the data stored in the memory, and may control the overall operation of the components in the user terminal 200 through the generated control signal.

For example, the terminal control unit 240 may control to display various types of information on the display 210 through a control signal. When an interpreted/translated video of one caller is received from the video call device 100 through the terminal communication unit 230, the terminal control unit 240 may display the interpreted/translated video of a counterpart on the video call on the display 210 as shown in FIG. 3.

In addition, the terminal control unit 240 may control to display a user interface for inputting various setting commands of a video call service on the display 210, and may change the configuration of the user interface based on the setting commands input through the user interface.

For example, when a user clicks the icon 12 shown in FIG. 3, the terminal control unit 240 may control to reduce the region where an interpreted/translated video related to the video call is displayed as shown in FIG. 4, and display a user interface configured to display an icon for receiving various setting commands from the user on the display 210.

Specifically, referring to FIG. 4, the terminal control unit 240 may control to display, on the display 210, a user interface which includes an icon for receiving a video caller invitation command, a translation language selection command, a speaking right setting command, an electronic blackboard command, a keyboard activation command, a subtitle setting command, other setting commands, and the like, and the setting commands that can be input are not limited to the examples described above.

The video call system 1 according to an embodiment may provide a multi-party video call service, as well as a one-to-one video call service. Accordingly, when a user invites another user by clicking a video caller invitation icon, the terminal control unit 240 may additionally partition the region in which the video call-related video is displayed in accordance with the number of invited users. In an embodiment, when a user additionally invites two callers during a video call with one caller to perform a video call with a total of three callers, the terminal control unit 240 may display, as shown in FIG. 5, a user interface configured to display the videos of the three callers in the first to third regions (R1, R2, R3) and the original language/translation information (M1, M2, M3) of the callers in the first to third regions (R1, R2, R3), respectively. When one caller is additionally invited at this point, the terminal control unit 240 may display the video and the original language/translation information of the newly added caller in the fourth region R4, and there is no limitation.

On the other hand, when a user performs a setting related to a right to speak by clicking a speaking right setting icon, the terminal control unit 240 may display the video of a user having a right to speak to be highlighted through various methods.

For example, as shown in FIG. 6, the terminal control unit 240 may control to display the user interface on the display 210 to provide only the original language/translation information M1 of a user having a right to speak while the video of the caller having a right to speak is enlarged. As another example, the terminal control unit 240 may change the user interface so that a caller who has a right to speak may be distinguished from callers who do not have a right to speak through various methods, for example, the terminal control unit 240 may change the user interface to provide only the video and the original language/translation information of the caller having a right to speak to be displayed on the display 210, and there is no limitation.

A method of configuring the user interface described above may be implemented as a data in the form of a program or an algorithm and previously stored in the user terminal 200 or the video call device 100. When the method is previously stored in the video call device 100, the terminal control unit 240 may control to receive the data from the video call device 100 through the terminal communication unit 230, and then display the user interface on the display 210 based on the data. Hereinafter, the operation of the video call device will be described briefly.

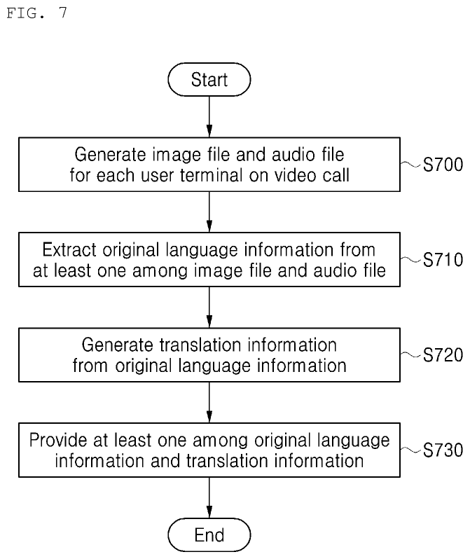

FIG. 7 is a flowchart schematically showing the operation flow of a video call device according to an embodiment.

The video call device may provide a video call service by connecting a plurality of user terminals through a communication network, and in this case, it may receive a video call-related video file through the user terminal. The video call-related video file is a data generated using at least one among a camera and a microphone embedded in the user terminal, and may mean a data in which communication details are stored through at least one among the camera and the microphone described above.

The video call device may generate an image file and an audio file for each user terminal based on the video call-related video file received from each user terminal (700), and extract original language information for each user terminal using at least one among the generated image file and audio file (710).

Here, the original language information is information expressing communication details stored in the video call-related video in the form of at least one among a voice and text, and it corresponds to the information before being translated in a language of a specific country.

The video call device may extract the original language information by using both or only one among the image file and the audio file according to a communication means used by the callers appearing in the video call-related video.

For example, when one of the callers appearing in the video call-related video makes a video call using a voice while another caller is making a video call using a sign language, the video call device may extract the original language information by identifying a sign language pattern from the image file, and extract the original language information by identifying a voice from the audio file.

As another example, when callers make a video call using only a voice, the video call device may extract the original language information using only the audio file, and as another example, when callers are having a conversation using only a sign language, the video call device may extract the original language information using only the image file.

The video call device may generate translation information using the original language information in response to a request of the callers (720), and then provide at least one among the original language information and the translation information through a communication network (730). For example, the video call device may facilitate communications between callers by transmitting an interpreted/translated video in which at least one among the original language information and the translation information is mapped to the video call-related video.

The configurations shown in the embodiments and drawings described in the specification are only preferred examples of the disclosed invention, and there may be various modified examples that may replace the embodiments and drawings of this specification at the time of filing of the present application.

In addition, the terms used in this specification are used to describe the embodiments, and are not intended to limit and/or restrict the disclosed invention. Singular expressions include plural expressions unless the context clearly dictates otherwise. In this specification, terms such as “comprises” or “have” are intended to specify presence of the features, numbers, steps, operations, components, parts, or combinations thereof described in this specification, and do not preclude the possibility of presence or addition of one or more other features, numbers, steps, operations, components, parts, or combinations thereof.

In addition, although the terms including ordinal numbers, such as “first”, “second”, and the like, used in this specification may be used to describe various components, the components are not limited by the terms, and the terms are used only for the purpose of distinguishing one component from other components. For example, a first component may be referred to as a second component without departing from the scope of the present invention, and similarly, a second component may also be referred to as a first component. The term “and/or” includes a combination of a plurality of related listed items or any one item of the plurality of related listed items.

In addition, the terms such as “˜ unit”, “˜ group”, “˜ block”, “˜ member”, “˜ module”, and the like used throughout this specification may mean a unit that processes at least one function or operation. For example, the terms may mean software or hardware such as FPGA or ASIC. However, “˜ unit”, “˜ group”, “˜ block”, “˜ member”, “˜ module”, and the like are not a meaning limited to software or hardware, and “˜ unit”, “˜ group”, “˜ block”, “˜ member”, “˜ module”, and the like may be configurations stored in an accessible storage medium and executed by one or more processors.

DESCRIPTION OF SYMBOLS

| | |
|---|---|
| 1: Refrigerator | 20, 30: Storage compartment |
| 21, 22: Storage compartment door | |
| 160: Display | |

1. A video call device comprising:
a communications unit for supporting a video call service between a plurality of user terminals through a communication network;
an extraction unit for generating an image file and an audio file using a video call-related video file collected from each of the plurality of user terminals, and extracting original language information from at least one among the image file and the audio file;
a translation unit for generating translation information from the original language information; and
a control unit for controlling transmission of an interpreted/translated video, in which at least one among the extracted original language information and the translation information is mapped to the video call-related video file.

2. The device according to claim 1, wherein the original language information includes at least one among voice original language information and text original language information, and the translation information includes at least one among voice translation information and text translation information.

3. The device according to claim 1, wherein the extraction unit extracts voice original language information for each caller by applying a frequency band analysis process to the audio file, and generates text original language information by applying a voice recognition process to the extracted voice original language information.

4. The device according to claim 1, wherein the extraction unit detects a sign language pattern by applying an image processing process to the image file, and generates text original language information based on the detected sign language pattern.

5. A user terminal comprising:
a terminal communication unit for supporting a video call service through a communication network; and
a terminal control unit for controlling to display, on a display, a user interface configured to provide an interpreted/translated video, in which at least one among original language information and translation information is mapped to a video call-related video file, and provide an icon for receiving at least one or more video call-related setting commands and at least one or more translation-related setting commands.

6. The terminal according to claim 5, wherein the at least one or more video call-related setting commands include at least one among a speaking right setting command capable of setting a right to speak of a video caller, a command for setting the number of video callers, a blackboard activation command, and a text transmission command.

7. The terminal according to claim 6, wherein the terminal control unit controls to display, on the display, a user interface configured to be able to change a method of providing the interpreted/translated video according to whether or not the speaking right setting command is input, or to provide a pop-up message including information on a caller having a right to speak.

8. The terminal according to claim 6, wherein the terminal control unit controls to display a user interface configured to provide a virtual keyboard in a preset region on the display when the text transmission command is received.

9. A control method of a video call device, the method comprising the steps of:
receiving a video call-related video file from a plurality of user terminals through a communication network;
extracting original language information for each caller using at least one among an image file and an audio file generated from the video call-related video file;
generating translation information of the original language information translated according to a language of a selected country; and
controlling to transmit an interpreted/translated video, in which at least one among the original language information and the translation information is mapped to the video call-related video file.

10. The method according to claim 9, wherein the extracting step includes the steps of:
extracting voice original language information for each caller by applying a frequency band analysis process to the audio file; and
generating text original language information by applying a voice recognition process to the extracted voice original language information.
